(19) United States
(12) Patent Application Publication
(10) Pub. No.: US 2026/0038043 A1
(43) Pub. Date: Feb. 5, 2026

(54) DYNAMIC ALLOCATION OF LOCATIONS OF MATCHING ENGINES IN A CLOUD-BASED EXCHANGE

(71) Applicant: Jonathon Fletcher, Seattle, WA (US)

(72) Inventor: Jonathon Fletcher, Seattle, WA (US)

(21) Appl. No.: 19/355,242

(22) Filed: Oct. 10, 2025

Related U.S. Application Data
(63) Continuation of application No. 17/543,211, filed on Dec. 6, 2021, now abandoned.

(51) Int. Cl. G06Q 40/04; G06F 9/50

(52) U.S. Cl. CPC G06Q 40/04; G06F 9/5072; G06F 9/5077

(57) ABSTRACT

Various systems and methods for allocating computing resources, such as matching engines or order books, to participants within a cloud-based trading exchange are described. In some embodiments, the systems and methods dynamically allocate cloud-based instances (e.g., instances at different locations) of matching engines to trading sessions of assets. Such dynamic allocation can avoid, prevent, or mitigate participants gaining an advantage based on their geographic or physical location relative to the geographic location (or locations) of the instances of the matching engines. Further, such allocation of resources can be performed using randomization or other allocation techniques.

### CROSS REFERENCE TO RELATED APPLICATIONS

This application is a continuation of U.S. patent application Ser. No. 17/543,211, filed on Dec. 6, 2021, entitled DYNAMIC ALLOCATION OF LOCATIONS OF MATCHING ENGINES IN CLOUD-BASED EXCHANGE, which is hereby incorporated by reference in its entirety.

### BACKGROUND

Exchanges are online marketplaces where commodities, securities (e.g., stocks), derivatives (e.g., options), and other financial instruments are traded (e.g., bought or sold). Typically, exchanges utilize data centers positioned at a certain physical location (along with a different backup location), and market participants communicate with the data centers during trading sessions.

This arrangement of data centers has provided arbitrage opportunities for participants due to the inherent latency of communications between servers across a physical distance. Dubbed “latency arb,” participants have attempted to position their trading systems (e.g., servers or other computing devices) as physically close to the data centers of exchanges as is possible, in order to benefit from a timing advantage with respect to other participants who are located further away from the data centers.

Latency arbitrage arises in a few ways-during the communication of orders (e.g., order placements, order cancellations, order modifications, order executions, and other order events) between participants and exchange data centers and during the communication of market-data information to participants.

Participants take advantage of latency arbitrage due to market-data information latency by receiving information about order books and matching engines (e.g., information about an asset being traded) before other participants. Similarly, participants take advantage of latency in order events because they can perform actions associated with orders (e.g., place, modify, cancel) with less delay than other participants.

For example, latency in order events can be observed and/or measured by market participants and utilized as an input to subsequent order events (e.g., advantaged participants can have orders for assets arrive at multiple exchanges at the same time, based upon the relative order event latencies available to the market participant for each exchange). Further, market information latency can be measured and observed via the order events of a market participant, such that the appearance of a market participant's order event information in the market data communication can allow for the estimation of the market data latency relative to the (observed) order event latency.

In some cases, an exchange can attempt to minimize latency arbitrage for participants by modifying the distance via which communications can travel (e.g., installing very long runs of cable between participant servers and the trading system data centers).

Currently, exchanges and trading systems, like other technology platforms, may move to cloud-based platforms, building on the abstractions and provisioning layers of cloud providers. Like specific, physically located, data centers, cloud providers operate in “regions” where specific data centers in physical locations are used singularly, or in combination, to provide a “region” or physical location for their cloud-based servers.

One problem with migration to cloud-based platforms is that exchanges earn revenue by charging market participants for connectivity and access to the physical location of the exchange. Further, the exchanges can earn revenue when processing order events and for distributing market-data to market participants.

Also, moving an exchange to cloud-based data centers does not remove the opportunity for latency arbitrage, because market participants can and will move their trading systems to the same region(s) as the exchange, to benefit from reduced latency relative to a market participant operating from a physically distant or different region.

### BRIEF DESCRIPTION OF THE DRAWINGS

Embodiments of the present technology will be described and explained through the use of the accompanying drawings.

FIG. 1 is a block diagram illustrating a suitable network environment for dynamically allocating trading resources to participants of an exchange.

FIGS. 2A-2E are diagrams illustrating the dynamic allocation of instances of matching engines within a cloud-based trading exchange.

FIG. 3 is a flow diagram illustrating a method for facilitating trading of assets via a cloud-based trading exchange.

FIG. 4 is a flow diagram illustrating a method for re-allocating computing resources within a cloud-based trading exchange.

FIG. 5 is a flow diagram illustrating a method for allocating instances of matching engines to trading sessions within a cloud-based trading exchange.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods for allocating computing resources, such as matching engines or order books, to trading sessions within a cloud-based trading exchange are described. In some embodiments, the systems and methods dynamically allocate cloud-based instances (e.g., cloud instances or virtual server instances) of matching engines to trading sessions of assets to avoid, prevent, or mitigate any participants gaining an advantage based on their geographic or physical location relative to the geographic location (or locations) of the matching engines.

In doing so, the systems and methods seek to allocate resources using randomization or other dynamic allocation mechanisms aimed at providing participants with fair and equitable access to the cloud-based trading exchange, among other benefits.

In some embodiments, the systems and methods randomly allocate access to computing resources, such as matching engines or order books, for each trading session facilitated or supported by the cloud-based trading exchange. For example, the exchange can include or provide one location of multiple possible cloud instances for each matching engine, where each cloud instance is or maybe positioned at a different geographic location from the other cloud instances of the matching engine. Thus, when a participant accesses a trading session, the exchange, via the systems and methods described herein, has already assigned the cloud instance to the session.

The exchange, therefore, prevents the participants from utilizing a geographically close (or closest) matching engine for all trading sessions within the exchange, and instead allocates resources to the participants in a random or other manner. Using such dynamic allocation, the exchange mitigates the latency arb opportunities for any participant based on their relative physical location to the data centers (and, therefore, matching engines) of the exchange, providing participants of the exchange with a fair and equal opportunity to trade assets and benefit from activities facilitated by the exchange, among other benefits.

Various embodiments of the system and methods will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Exchange Environment

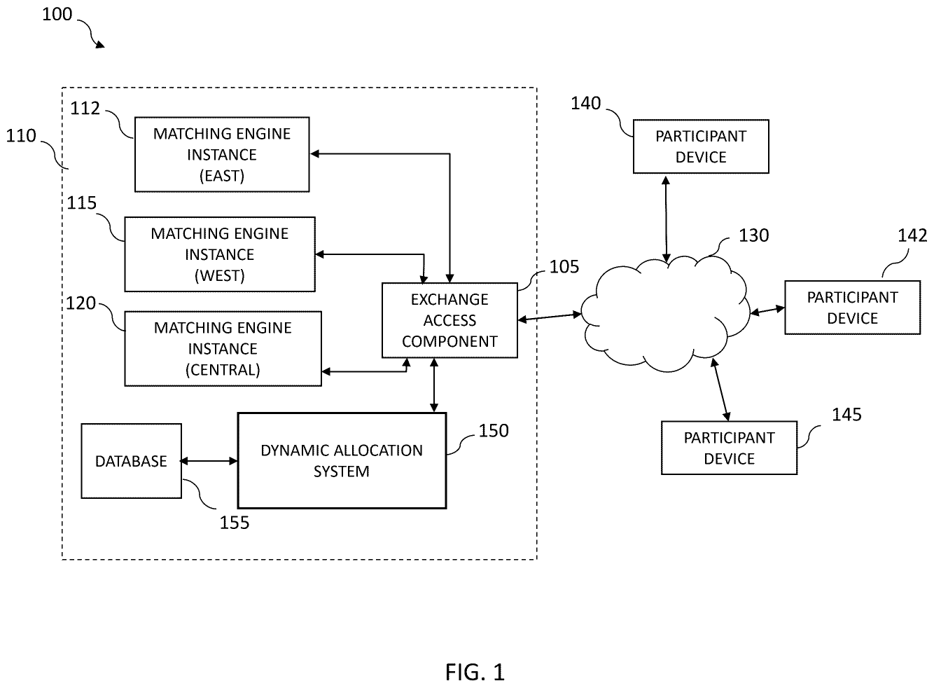

The technology described herein is directed, in some embodiments, to providing computing resources of a cloud-based trading exchange to participants of the exchange. FIG. 1 is a block diagram illustrating a suitable network environment 100 for dynamically allocating trading resources within an exchange.

A cloud-based trading exchange 110 includes various computing resources, such as a matching engine having or being provided by multiple cloud-based instances 112, 115, 120. The matching engine facilitates the trading of an asset and/or financial instrument within the trading exchange 110. The matching engine is provided by the various resources, and in some cases are positioned or located at different geographic or physical locations. For example, the cloud-based instance 112 of the matching engine can be located on or near the east coast of the US (e.g., outside NYC), the cloud-based instance 115 of the matching engine can be located on or near the west coast of the US (e.g., outside LA), and the cloud-based instance 120 of the matching engine can be in the central US (e.g., outside Chicago).

Of course, the instances (e.g., cloud instances or virtual server instances) of the matching engine can be at other or different locations, such as at different positions within a region or location. For example, the cloud-based trading exchange can include the multiple instances 112, 115, 120, some or all of which are located at a single cloud-based data center or server region, or distributed across multiple different server regions (e.g., different physical regions).

The cloud-based trading exchange 110 can provide multiple different matching engines (e.g., or order books or securities information processors), which support a trading session or sessions for an asset or assets traded via an exchange. For example, the trading exchange 110 utilizes one matching engine for each traded asset for each ongoing trading session within the exchange 110.

As described herein, the cloud-based trading exchange 110 facilitates and manages the trading of various financial assets or instruments (e.g., commodities, securities, tokens, currencies, cryptocurrencies, and so on) by supporting trading sessions between the participants of the exchange. The exchange 110 can be a multi-level trading platform or other tiered information exchange.

Various participants access the cloud-based trading exchange 110 using participant devices 140, 142, 145 that communicate with the exchange 110 over a network 130, such as a wireless or telecommunications network, or via hardwired cables that connect their devices to the exchange 110 via an exchange access component 105, such as an exchange provided gateway. The participant devices 140, 142, 145 can be servers or other computing devices, and provide an interface into the exchange 110 via which the participants can perform trading operations, such as submitting, modifying, and cancelling orders, and other order events. As described herein, each participant device 140, 142, 145 sits or is positioned at a certain physical location, and accesses the exchange 110 by connecting into the exchange 110 at the exchange access component 105, such as one or more exchange provided connection points or gateways.

As described herein, the systems and methods utilize a dynamic allocation system 150 to dynamically allocate computing resources of the cloud-based trading exchange 110, such as allocating the cloud-based instances 112, 115, 120 for each matching engine provided for a trading session. Each trading session is provided by the exchange and utilized by the participant devices 140, 142, 145 to perform trading operations. In some cases, the system 150 dynamically locates a matching engine for every trading session within the exchange 110 (e.g., via the selection of a cloud-based instance of the matching engine).

The dynamic allocation system 150 can perform various processes, operations techniques, or methods when allocating resources of the trading exchange 110 for trading sessions supported by the exchange 110. As will be described herein, the dynamic allocation system 150 can utilize randomization mechanisms, optimization mechanisms, and other mechanisms, when allocating resources to new trading sessions or in response to other events or actions within the cloud-based trading exchange 110.

Further, while the dynamic allocation system 150 is depicted in FIG. 1 as being part of or supported by the exchange 110, the system 150 can, in some cases, utilize the system 150 as a separate or distinct component that communicates with the exchange 110 via the network 130. For example, the exchange 110 can include some or all aspects of the system 150, or can access some or all aspects at servers not controlled by the exchange 110 and/or provided by a third party entity.

The dynamic allocation system 150 can track or manage some or all matching engine allocation decisions and actions via a database 155. The database 155, which can be maintained to satisfy regulators, participants, or other stakeholders of the exchange 110, can store various types of information associated with allocation, or reallocation, of resources, such as cloud instances 112, 115, 120 of the matching engine and other allocation events. Example information managed by the database 155 includes information that identifies a matching engine, cloud-based instance, and associated location, an asset and related assets, an applied allocation mechanism, and other information.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) or cloud service or instance to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network or cloud 130 can be any network, ranging from a wired or wireless local area network (LAN), to a wired or wireless wide area network (WAN), to the Internet or some other public or private network, to a cellular (e.g., 4G, LTE, or 5G network), and so on. While the connections between the various devices and the network 130 and are shown as separate connections, these connections can be any kind of local, wide area, wired, or wireless network, public or private.

Further, any or all components depicted in the Figures described herein can be supported and/or implemented via one or more computing systems, servers, or services (e.g., cloud or virtual services). Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of Dynamically Allocating Computing Resources of a Trading Exchange

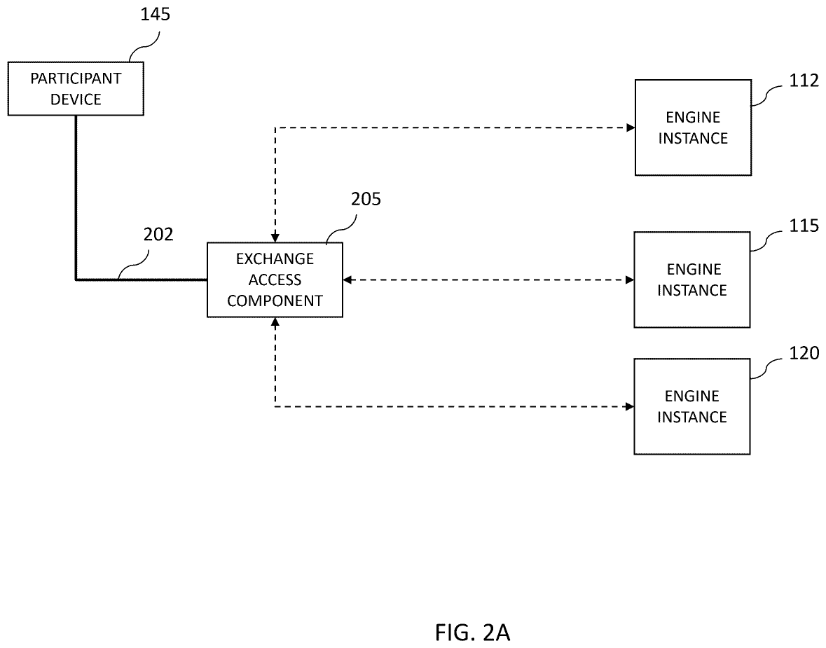

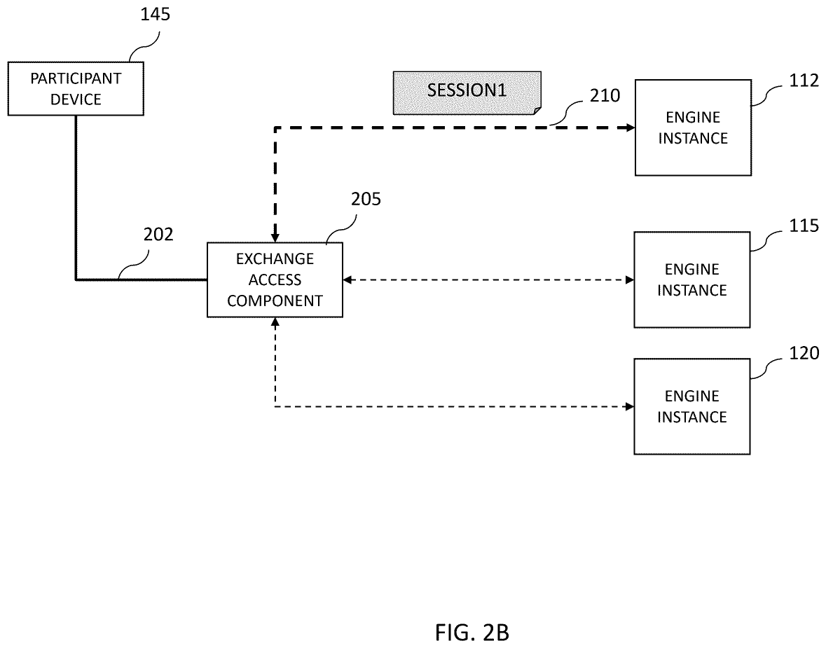

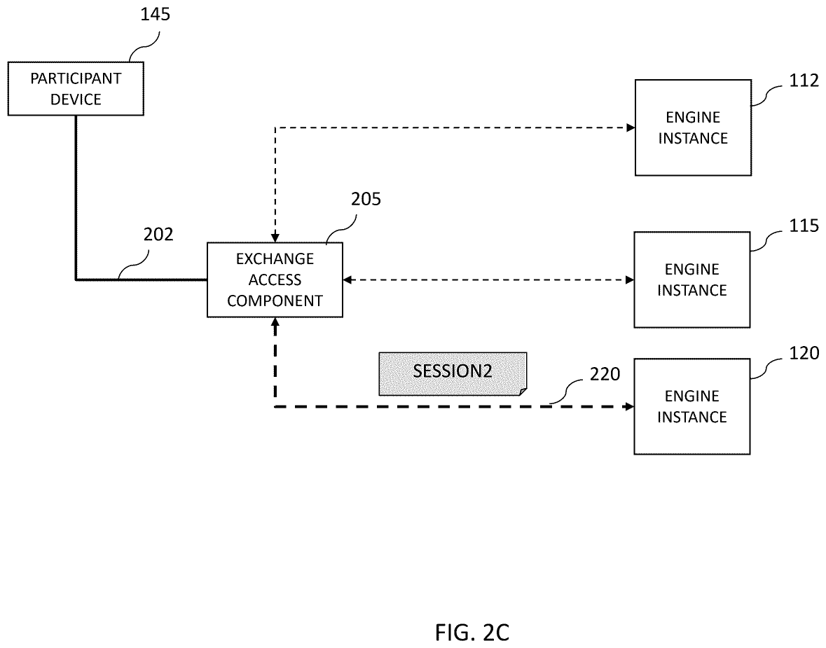

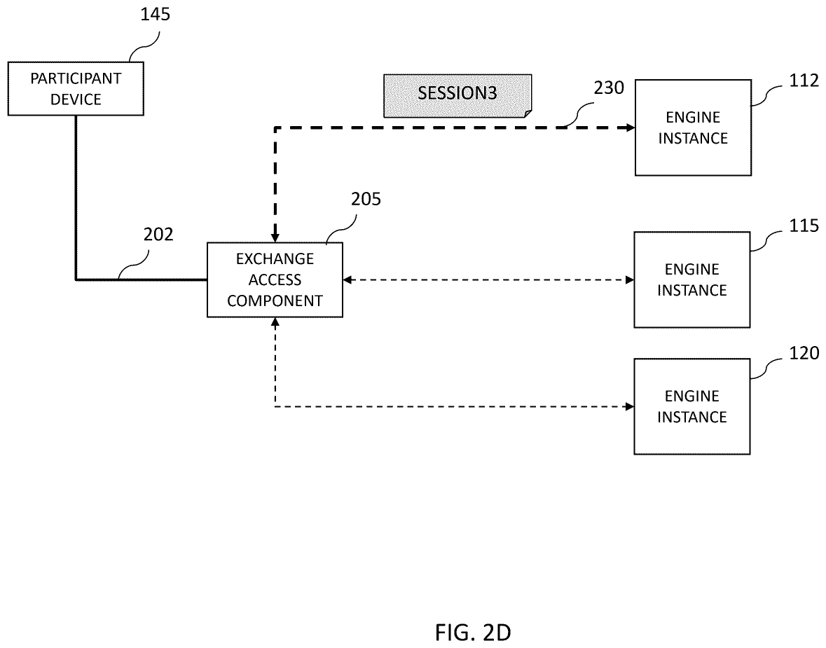

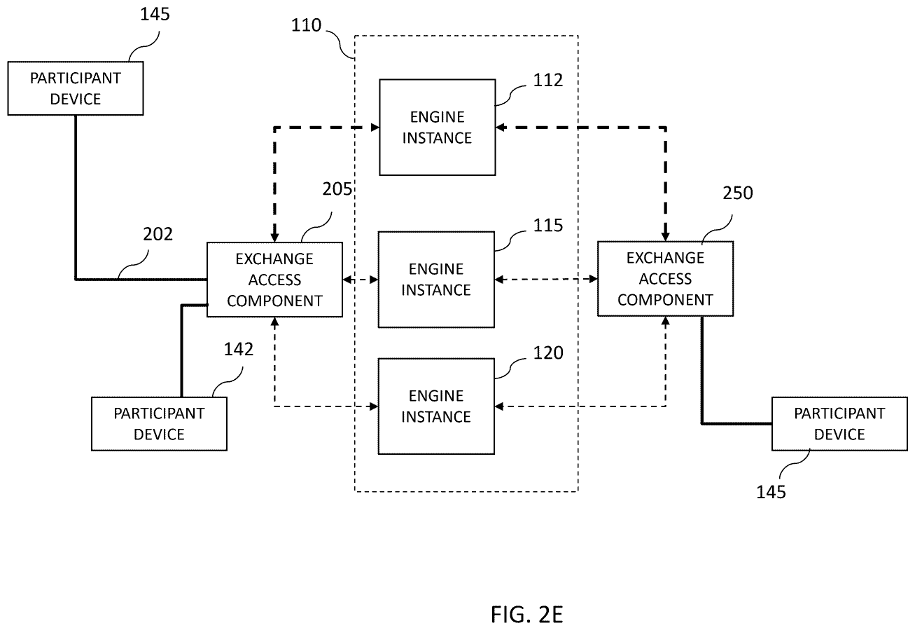

As described herein, in some embodiments, the dynamic allocation system 150, or allocation system, allocates the cloud-based instances 112, 115, 120 to new trading sessions, accessible by the participant devices 140, 142, 145, within the exchange 110. Thus, the system 150 allocates, or re-allocates, a cloud instance of a matching engine dynamically, or in response to information associated with a trading session or other event within the exchange. FIGS. 2A-2E depict the dynamic allocation of matching engines within the cloud-based trading exchange 110.

FIG. 2A depicts a simplified cloud-based trading exchange, where the three cloud-based instances 112, 115, 120 are available and possible candidates to be allocated (or re-allocated) for a trading session before commencement of the trading session within the exchange 110. Each of the cloud-based instances is at a different geographic location. For example, the cloud-based instance 120 is located proximate or at a similar location to the participant device 145, while the other instances 112, 115 are at different locations remote from the location of the participant device 145.

The participant device 145 communicates with the exchange 110 over a wired connection 202 and via an exchange access component 205 (e.g., a gateway). Once an instance is selected for a trading session, the participant device 145 can communicate with the allocated instance (via the wired connection 202 and any internal communications channels of the exchange that facilitate communications between the exchange access component 205 and the selected instance).

FIG. 2B depicts the dynamic allocation of the instances for a new trading session (“Session1”) associated with the trading of a given or specific asset. As depicted, the dynamic allocation system 150 utilizes an allocation mechanism (e.g., random selection) to allocate 210 the instance 112 to the trading session of the given or specific asset.

The dynamic allocation system 150, for a new or subsequent trading session (“Session2”) for the asset, utilizes the allocation mechanism and allocates 220, as depicted in FIG. 2C, the instance 120 for the trading session of the asset. Thus, the allocation mechanism, via the system 150, follows the randomization mechanism or other location-independent or fair allocation techniques in order to determine or select the location of the matching engine from the candidate instances (112, 115, 120) for each trading session of the asset.

At yet another later time, the dynamic allocation system 150, for a new or subsequent trading session (“Session3”) for the asset, allocates 230, as depicted in FIG. 2D, the instance 112 to the trading session of the asset. Thus, the system 150, can at times allocate the same instance for different trading sessions of an asset, because the allocation follows the randomization mechanism or other location-independent or fair allocation techniques.

Although FIGS. 2A-2D depict a simplified version of how the dynamic allocation system 150 operates to locate a matching engine for a trading session, the system 150 can utilize more complex techniques or allocate more resources. For example, the system 150 can utilize the allocation techniques described herein to allocate cloud-based resources to a given cloud-based region or data center, and/or with more available cloud instances for matching engines (e.g., 10, 100, or more) not depicted in the Figures.

For example, FIG. 2E depicts a new trading session (“Session4’), where two participant devices 142 and 145 access the exchange via the same exchange access component 205, and one of the participant devices 145 accesses the exchange via multiple different access components 205 and 250 (e.g., from two different physical locations). In such cases, the allocation system 150, by dynamically allocating the location of the matching engine for the trading session (via the cloud-based instances), can provide fair or equitable access to both participant devices, regardless of their physical locations with respect to the exchange.

As described herein, the dynamic allocation system 150 performs various techniques when facilitating the trading of assets and other financial instruments within the cloud-based trading exchange 110. The system 150 can include various modules that perform different operations. The modules can be implemented with a combination of software (e.g., executable instructions, or computer code) and hardware (e.g., at least a memory and processor). Accordingly, as used herein a module is a processor-implemented module and represents a computing device having a processor that is at least temporarily configured and/or programmed by executable instructions stored in memory to perform one or more of the functions that are described herein.

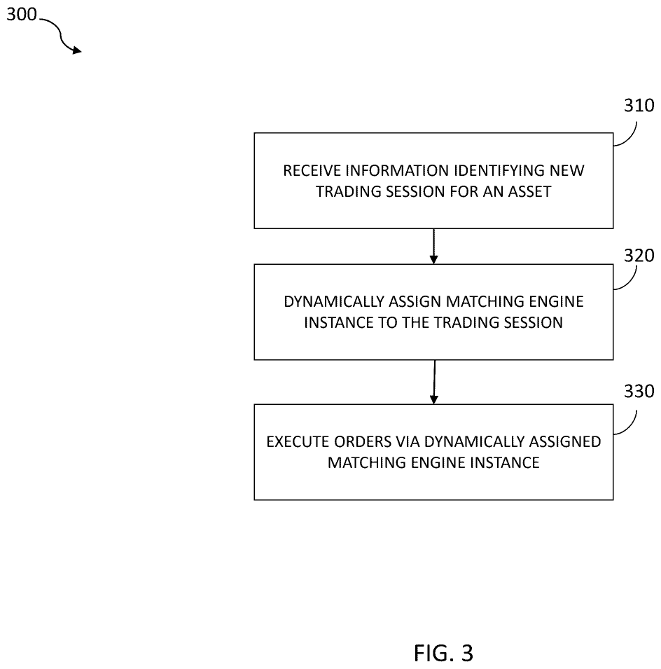

FIG. 3 is a flow diagram illustrating a method 300 for facilitating the trading of assets via the cloud-based trading exchange 110. The method 300 may be performed by the dynamic allocation system 150 and, accordingly, is described herein merely by way of reference thereto. It will be appreciated that the method 300 may be performed on any suitable hardware.

In operation 310, the dynamic allocation system 150 receives an indication of a new trading session for an asset within the cloud-based trading exchange 110. For example, the system 150 can receive an indication of a new trading session (e.g., the time for a new session will commence and/or is prompted to allocate matching engine instances for an upcoming session).

In operation 320, the dynamic allocation system 150 allocates a cloud-based instance of a matching engine to the new trading session in response to the received indication of the new trading session. For example, the system 150, dynamically and in response to the received indication, allocates the cloud-based instance 115 to the new trading session using a randomization technique that selects an instance from a set of available or eligible instances. The system 150, as described herein, can utilize other allocation techniques separately or in combination with the random selection of the instance.

In some cases, the system 150 can randomly select the cloud-based instance from a set of available cloud-based instances For example, the system 150 may, before selecting a cloud-based instance, gather, identify, and/or determine information associated with the availability of the instances, the current or predicted usage of the instances, the type of trading sessions occurring at the instances, and so on. Using the information received from the cloud-based instances, the system 150 can determine which instances are available or eligible for utilization, and randomly select a cloud-based instance from the determined set of available instances

In operation 330, the dynamic allocation system 150 causes the exchange to configure the trading session using the dynamically allocated or assigned cloud-based instance. For example, the system 150, having randomly assigned the cloud-based instance 115 to the trading session, facilitates the routing inside the exchange that enables the participants to trade assets on the allocated instance for the duration of the session.

As described herein, in some embodiments, the system 150 can allocate, or re-allocate, one, some, or all cloud-based instances to trading sessions in response to the occurrence of an event or condition within the cloud-based trading exchange 110. The system 150, therefore, can modify the allocation of resources for some or all resources of the exchange 110.

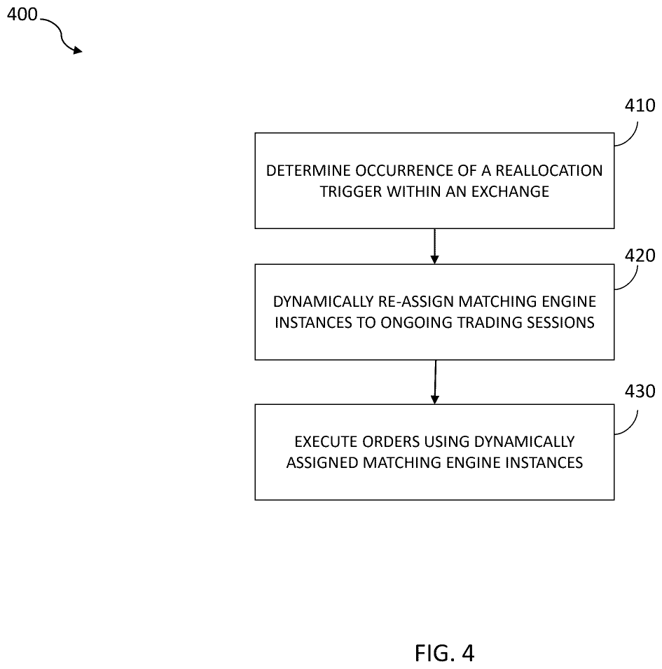

FIG. 4 is a flow diagram illustrating a method 400 for re-allocating computing resources within a cloud-based trading exchange. The method 400 may be performed by the dynamic allocation system 150 and, accordingly, is described herein merely by way of reference thereto. It will be appreciated that the method 400 may be performed on any suitable hardware.

In operation 410, the dynamic allocation system 150 determines, identifies, and/or receives an occurrence of a reallocation trigger within the cloud-based trading exchange 110. For example, the system 150 can receive information indicating the allocation of resources is or is predicted to be sub-optimal with respect to efficiency of provisioning or resources, capacity or network throughput of or at certain regions or resources, costs associated with operating the exchange 110, unfair or sub-optimal allocation of resources to one or more participants, and so on.

In operation 420, the dynamic allocation system 150 dynamically re-assigns the instances for each of the matching engines to ongoing trading sessions. For example, the system 150 can cause some or all of the matching engines to utilize different instances in response to the trigger or indication of sub-optimal conditions.

In operation 430, the dynamic allocation system 150 executes the trading sessions (e.g., performs trading operations, such as submitting, modifying, and cancelling orders) using the dynamically re-allocated or re-assigned instances of the matching engines. For example, the system 150 optimizes or enhances operations of the exchange 110 and resumes execution of trading sessions via the optimized allotment or configuration of resources.

In some embodiments, the dynamic allocation of resources can cause certain types of failure modes for the exchange 110. For example, failure modes can arise from connectivity issues, resource performance issues, activity level issues, and so on. When an exchange, such as the exchange 110, is capable of relocating or reallocating instances for matching engines based upon a set of incentives, the exchange can also utilize the techniques to reallocate matching engines in response to failure events. Thus, the exchange 110, being capable of dynamically relocating or reallocating access locations to matching engines, can be more resilient to matching engine failures than an exchange which does not utilize relocation or reallocation techniques.

Further, in some embodiments, the market participants may seek to dynamically relocate their trading systems to be as close to a given matching engine as possible. They may attempt to do so during a trading session based upon information from their order event and market data communications. The system 150, therefore, can utilize such information to identify and/or predict participant dynamic relocation attempts and adapt the allocation process accordingly (e.g., trigger the reallocation of resources and/or initiate a review by the exchange of participant behavior).

Regardless of whether the system 150 is dynamically allocating resources for a new trading session or re-allocating resources to modify, balance, or optimize the resources provided by the exchange 110, the system 150 can select or implement various resource selection mechanism when determining which resources (e.g., instances or other access locations for matching engines) to allocate fairly to participants.

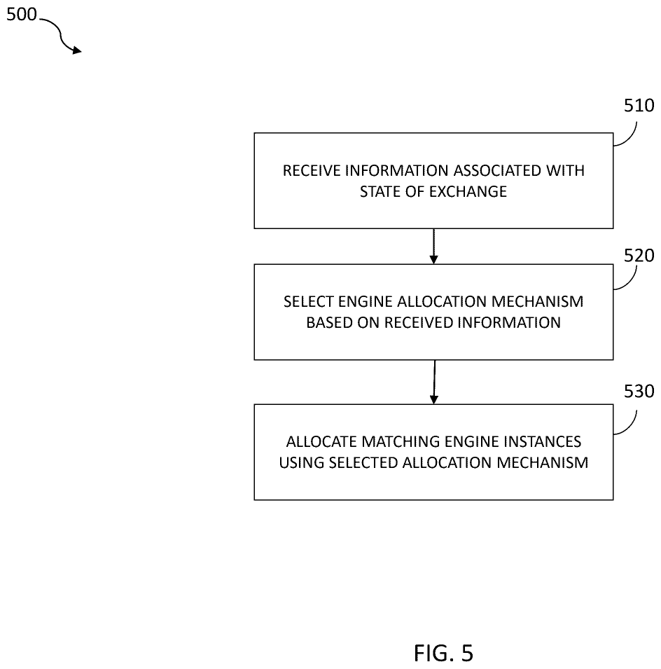

FIG. 5 is a flow diagram illustrating a method 500 for allocating cloud-based instances of a matching engine to trading sessions within a cloud-based trading exchange. The method 500 may be performed by the dynamic allocation system 150 and, accordingly, is described herein merely by way of reference thereto. It will be appreciated that the method 500 may be performed on any suitable hardware.

In operation 510, the dynamic allocation system 150 receives information associated with a state or condition of the cloud-based trading exchange 110. For example, the system 150, optionally, receives or retrieves information associated with the exchange 110, such as information associated with the use or utilization of resources, the performance of the resources, the assets and types of assets being traded, the participants trading the assets, the costs associated with running the exchange or portion of the exchange, and so on.

In operation 520, the dynamic allocation system 150 selects an allocation mechanism based on the received information. For example, the system 150 can determine the exchange 110 is operating normally, sufficiently (e.g., above one or more threshold parameters), or optimally and select a randomization mechanism when allocating a matching engine instance to a trading session.

In some cases, the system 150 selects other allocation mechanisms or techniques that utilize the random selection of available or eligible instances of matching engines. For example, the system 150 can select a cloud-based instance for a matching engine at a geographic location that is different from the geographic location of an instance of a matching engine facilitating an ongoing or previous trading session for an asset that is correlated to an asset associated with the new trading session.

Further, the system 150 can review the performance or operation of the exchange 110, and randomly select an instance of a matching engine from a set of instances having an activity level below a threshold activity level for the cloud-based trading exchange 110 and/or having a performance level above a threshold performance level for the cloud-based trading exchange 110. In some cases, the system 110 can predict the activity level (or performance level) and select resources that are predicted to be below the activity level threshold and/or above the performance level threshold.

In some cases, the system 150 can allocate resources based on distributing the trading of related assets to different and unique geographical locations. For example, the system 150 can dynamically allocate an instance for a matching engine based on relationships between the asset associated with the new trading session of that matching engine and other related assets, and the dynamically selected locations of their matching engines (e.g., an index fund that includes the asset or other assets of a common or shared fund or index) being traded via the cloud-based trading exchange 110.

Thus, the system 150 can allocate or determine the availability of a cloud-based instance or access location for a matching engine based on relationships between the asset associated with the new trading session and index funds that include the asset also being traded via the cloud-based trading exchange.

In some cases, the system 150 can track the use or utilization of cloud-based instances of matching engines and modify the set of available resources after every trading session. For example, an exchange having 50 possible instances for matching engines can allocate (randomly or using another heuristic) for a sequence of 50 trading sessions a different matching engine instance until all 50 matching engine instances have been utilized. Thus, the system 150 can employ the use of randomization while also ensuring that any participant does not take advantage, via luck or some other unintentional means, of utilizing certain matching engine locations closer to the participant for a certain set or sequence of trading sessions.

As described herein, the system 150, in some embodiments, seeks to maximize or enhance the fairness afforded to some or all participants of the cloud-based trading exchange 110. The various allocation techniques provide for such fairness, relying on the asymmetry of behaviors of exchanges and their participants. For example, when exchanges, or venues, treat matching engines as independent to one another, participants operate on the relationship between the multiple matching engines—from the same asset on multiple venues through to multiple assets on multiple venues.

In some cases, the system 150 can randomly choose matching engine dynamic locations to minimize all participants collective opportunities for latency arbitrage and promote agency fairness by the venue to all participants. The participants will have no information on where the matching engines will be for any given session, removing the latency arbitrage available to them that arises from the use of static locations or static allocation of resources.

In some cases, the system 150 may provide, for an exchange or venue, proof of agency fairness to regulators and participants. The use of random dynamic location assignment can provide such proof, and venues may wish to promote such an approach to dynamic locations as a proxy for agency fairness to existing and new participants of the exchange.

In some cases, a venue, using the system 150, can choose to dynamically locate matching engines based on the dynamic locations of matching engines for assets that are “related” in terms of return characteristics. “Related” in this context can mean that groups of companies are correlated and/or cointegrated, where the relationships can include business activity in similar markets and/or lead-lag relationships between the groups (e.g., shipping or logistics companies versus commercial or retail companies).

In some cases, a venue, using the system 150, can choose to dynamically locate matching engine locations based on the predetermined relationships found in indexes. For example, in a cap-weighted index, the tradable index asset (usually a futures contract, or a liquid ETF) is traded by participants against the constituents of the index. Dynamically distributing, as described herein, the constituents and the tradeable index asset(s) minimizes the opportunity for participant latency arbitrage. Further, the distribution could be based on the weightings of the constituent assets, with all available locations (and associated matching engines) being assigned comparable index weights and allocated based on these distributed weights.

In some cases, a venue, using the system 150, can choose to dynamically locate matching engines based on existing business relationships. For example, there are pricing and forward earning relationships with industry groups where a large manufacturer sources required components from multiple companies (e.g., auto companies and auto parts companies).

In some cases, a venue, using the system 150, can choose to dynamically locate matching engines based on underlying and/or derivative relationships. For example, the matching engine for an underlying asset could be dynamically distributed to be distant to the listed options of that underlying asset. With a large group of listed option strikes and expiries, dynamically distributing these matching engines can be complex, and based on liquidity, expiration dates, and how far the strike is from the prevailing spot price of the underlying asset.

In operation 530, the dynamic allocation system 150 allocates the location for the matching engine (e.g., selects an instance at or near the allocated location) using the selected allocation mechanism. For example, the system 150 allocates a cloud-based instance of the matching engine for a trading session, and the matching engine executes a desired or requested order event, such as a buy or sell order of an asset or instrument.

Thus, the dynamic allocation system 150, in some embodiments, is configured to perform a method for dynamical allocation of the location of order books (e.g., matching engines) of the cloud-based trading exchange 110. The method can include receiving an indication of a new trading session for an asset within the cloud-based trading exchange, and dynamically allocating a location of the matching engine to the new trading session in response to the received indication of the new trading session and/or the indication that a new trading session is about to commence or is scheduled to commence at a future time.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A trading exchange that facilitates trading of assets by participant entities of the trading exchange, the trading exchange comprising:
an exchange access gateway that facilitates access by the participant entities to trading services provided by the trading exchange;
a matching engine that operates to trade an asset for the trading exchange during trading sessions;
multiple cloud-based instances of the matching engine, wherein each cloud-based instance is supported by a virtual server that is located at a geographic location different from geographic locations of virtual servers of other cloud-based instances of the matching engine; and
an allocation system that:
dynamically selects, for every trading session for the asset associated with the matching engine, one of the multiple cloud-based instances, by:
receiving an indication of a unique trading session for the asset associated with the matching engine, and
selecting a cloud-based instance of the matching engine in response to the received indication of the unique trading session; and
routs trading requests during the unique trading session from the exchange access gateway to the virtual server that supports the dynamically selected cloud-based instance of the matching engine via internal communication channels of the trading exchange.

2. The trading exchange of claim 1, wherein the allocation system, in response to an indication of a new trading session for the single asset associated with the matching engine dynamically selects a different cloud-based instance of the multiple available cloud-based instances of the matching engine to the new trading session and routs trading requests during the new trading session from the exchange access gateway to a virtual server that supports the dynamically selected different cloud-based instance of the matching engine via the internal communication channels of the trading exchange.

3. The trading exchange of claim 1, wherein the allocation system dynamically selects one of the multiple cloud-based instances by randomly selecting a geographic location for the trading session and allocating a cloud-based instance located at the randomly selected geographic location to the matching engine associated with the trading session.

4. The trading exchange of claim 1, wherein the allocation system dynamically selects one of the multiple cloud-based instances by randomly selecting the cloud-based instance from a set of cloud-based instances of the multiple available cloud-based instances having an activity level below a threshold activity level for the trading exchange.

5. The trading exchange of claim 1, wherein the allocation system dynamically selects one of the multiple cloud-based instances by randomly selecting the cloud-based instance from a set of cloud-based instances of the multiple available cloud-based instances having a predicted activity level below a threshold activity level for the trading exchange.

6. The trading exchange of claim 1, wherein the allocation system maintains a database that tracks, for every dynamic allocation event for the trading exchange, information that identifies a cloud-based instance, a participant entity, an asset, and an applied allocation mechanism.

7. The trading exchange of claim 1, wherein the allocation system dynamically selects one of the multiple cloud-based instances based on relationships between assets being traded via the trading exchange.

8. The trading exchange of claim 1, wherein the allocation system dynamically selects one of the multiple cloud-based instances based on relationships between the participant entities.

9. The trading exchange of claim 1, wherein the allocation system dynamically selects one of the multiple cloud-based instances based on relationships between assets being traded via the trading exchange and index funds that include the assets also being traded via the trading exchange.

10. A method, comprising:
receiving an indication of a new trading session for an asset listed within a cloud-based trading exchange;
dynamically allocating a single cloud-based instance of a matching engine from multiple cloud-based instances available to the matching engine after receiving the indication of the new trading session,
wherein the allocated single cloud-based instance provides access to the matching engine for multiple participant devices during the new trading session; and
routing trading requests to the matching engine that are received from participant devices during the new trading session from an exchange access gateway, through which the participant devices access the cloud-based trading exchange, via the dynamically allocated single cloud-based instance of the matching engine.

11. The method of claim 10, wherein the allocated cloud-based instance is at a geographic location that is unique to and remote from geographic locations of other cloud-based instances available to the matching engine.

12. The method of claim 11, wherein the allocated cloud-based instance of the matching engine is at a geographic location different from geographic locations of other cloud-based instances associated with the matching engine that are facilitating ongoing or previous trading sessions for assets correlated to the asset.

13. The method of claim 10, wherein dynamically allocating a cloud-based instance to the new trading session includes randomly selecting the cloud-based instance from a set of available cloud-based instances available for the new trading session.

14. The method of claim 10, wherein dynamically allocating a cloud-based instance to the new trading session includes selecting a cloud-based instance at a geographic location that is different than the geographic location of a cloud-based instance facilitating a trading session for an asset that is correlated to an asset associated with the new trading session.

15. The method of claim 10, wherein dynamically allocating a cloud-based instance to the new trading session includes dynamically allocating the cloud-based instance based on relationships between participant devices trading assets via the cloud-based trading exchange.

16. The method of claim 10, wherein dynamically allocating a cloud-based instance to the new trading session includes dynamically allocating the cloud-based instance based on relationships between the asset associated with the new trading session and index funds that include the asset also being traded via the cloud-based trading exchange.

17. A non-transitory, computer-readable medium whose contents, when executed by a cloud-based trading exchange, causes the cloud-based trading exchange to perform a method for providing access for participants to order books of the cloud-based trading exchange, the method comprising:
receiving an indication of a new trading session for an asset within the cloud-based trading exchange,
wherein the asset is assigned to a specific matching engine of the cloud-based trading exchange for the new trading session;
dynamically selecting a single cloud-based instance, from multiple cloud-based instances of the specific matching engine, to provide access for the participants to the new trading session in response to the received indication of the new trading session,
wherein each of the multiple cloud-based instances are located at a geographic location that is unique to and remote from all other cloud-based instances of the cloud-based trading exchange, and
wherein the participants access the new trading session only via the dynamically selected single cloud-based instance of the matching engine;
receiving information regarding a sub-optimal condition associated with the selected single cloud-based instance during the new trading session; and
in response to the received information, selecting a different cloud-based instance of the specific matching engine to the new trading session during the new trading session.

18. The non-transitory, computer-readable medium of claim 17, wherein dynamically allocating a cloud-based instance of the matching engine to the new trading session includes randomly selecting the cloud-based instance of the matching engine from a set of available cloud-based instances.

19. The non-transitory, computer-readable medium of claim 17, wherein, for the new trading session of the asset assigned to the specific matching engine, dynamically selecting a single cloud-based instance from multiple cloud-based instances of the specific matching engine includes:
identifying geographic locations for cloud-based instances of other matching engines facilitating trading sessions for other assets that correlate to the asset; and
dynamically selecting a geographic location that is different from the identified geographic locations for the cloud-based instances of the other matching engines.

20. The non-transitory, computer-readable medium of claim 19, wherein the other assets are associated with businesses in similar markets with a business associated with the asset assigned to the specific matching engine or are index fund assets and the asset assigned to the specific matching engine is a constituent of the index fund assets.
